(19) United States
(12) Patent Application Publication
(10) Pub. No.: US 2004/0109967 A1
(43) Pub. Date: Jun. 10, 2004

(54) Packaging material, and method of and machine for producing the same

(76) Inventor: Leon Gershin, Millwood, NY (US)

Correspondence Address: Ilya Zborovsky, 6 Schoolhouse Way, Dix Hills, NY, 11746, US

(21) Appl. No.: 10/309,737

(22) Filed: Dec. 4, 2002

(51) Int. Cl. B32B 1/08

(52) U.S. Cl. 428/36.91; 428/36.9

(57) ABSTRACT

A packing element is formed as a tube element and which is composed of paper or a paper product and has two axial edges spaced from one another, wherein at least one edge is folded inwardly, outwardly or in both directions. A method of a machine for producing the packaging element are proposed as well.

### BACKGROUND OF THE INVENTION

The present invention relates to a packaging material, as well as to a method of and a machine for producing the same.

Packaging material composed of paper, such as so-called cushioning dunnage is disclosed for example in U.S. Pat. Nos. 5,328,732 and 5,468,525. This packaging material however possess the following disadvantages:

Insufficient carrier properties. During transportation vibration, shaking (buffeting) and multiple loading unloading occur. Weak bearing strength of paper-made cushioning dunnages is one of the common disadvantages.

Paper-made cushioning dunnages during transportation <<lose volume>>. Volume, which was filled with paper-made cushioning dunnages while packaging, decreases during transportation. Especially when shipped article has medium or big weight. Crumpling of paper-made cushioning dunnages leads to emptiness of container. That could be a reason of shipped articles damage.

Uncoiling of the paper-made cushioning dunnages. That leads to reduction of dunnages rigility and losing carrier ability, which is main property of filling material.

Paper-made cushioning dunnages have open edges. During transportation very small pieces of paper came out of dunnages. That is not suitable in most cases because it leads to contamination.

Even relatively small increment of humidity and presence of moisture can collapse paper-made cushioning dunnages carrier ability.

Oriental appearance of paper-made cushioning dunnage known designs is not good. That leads to shipped article trading.

### SUMMARY OF THE INVENTION

Accordingly, it is an object of the present invention to provide a packaging material which is a further improvement of the existing packaging materials.

It is also another object of the present invention to provide a method of and a machine for producing a new packaging material.

In keeping with these objects and with others which will become apparent hereinafter, one feature of the present invention resides, briefly stated, in a packaging material comprising a tubular element composed of a material selected from the group consisting of paper and a paper product, said tubular element having an axis and two axial ends spaced for one another, at least one of said edges being folded in a direction selected from the group consisting of inwardly, outwardly and both.

In accordance with another feature of the present invention, a method of producing the packaging material is proposed which comprises the steps of forming a tubular element of a material selected from a group consisting of paper and a paper product and having an axis and two axial edges spaced from one another in an axial direction; and folding at least one of said edges in a direction selected from the group consisting of inwardly, outwardly and both.

Finally, its another object of the invention to provide a machine for producing the packaging material which has means for forming a tubular element composed of a material selected from the group consisting of paper and a paper product and having an axis and two axial edges spaced from one another in an axial direction; and means for folding at least one of the edges of the tubular element in a direction selected from the group consisting of inwardly, outwardly and both.

In accordance with the present invention, the tubular element or tube can be made of paper or different kinds of paper products: cardboard, preliminary produced paper tubing, preliminary formed paper, with corrugating, multilayer papers where each layer is different, etc. At least one edge of the paper tube is folded in order to provide compression stiffness, rigidity, and carrier properties, wherein edges can be folded inside and/or outside. The paper tube with edges folded outside provides reduction of filing weight per unit volume. The paper tube before, after or during production is wetted and consequently dried in order to provide better rigidity. For the same purpose and to impart an improved look, knurls can be provided as well. Also, the paper tube can be impregnated to provide special properties: non-combustibility, anti-bacterial property, etc.

In a method of the present invention and with the machine in accordance with the present invention, all steps and mechanisms are provided to fulfill corresponding above-mentioned operations. Mechanisms are located in a working zone. Different instruments, including a forming instrument, can be delivered to the working zone in certain sequence. The working zone can be composed of several zones. Semi-finished article can be transported from one zone to another for different technological operations. Any technological operation can be combined with other operations. The machine for producing the material includes a unit for wetting of paper, semi-product or finished product. The forming instrument or other components of the machine can be used as a wetting unit or a part of the wetting unit. A special dryer performs drying. A heating forming instrument or other heating components of the machine can be used as a dryer or a part of the dryer unit.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a longitudinal section of a tubular element of packaging material of the invention.

FIG. 2 is a longitudinal section of the tubular element with different curvature.

FIG. 3 is a three layer tubular element folded edge.

FIG. 4 is a longitudinal section of the tubular element with edges folded inside.

FIG. 5 is a longitudinal section of the tubular element with edges folded outside.

FIG. 6 is a longitudinal section of the tubular element with one edge folded inside and another outside.

FIG. 7 is a longitudinal section of the conical tubular element with one edge folded inside and another outside.

FIG. 8 if a prospective view of the tubular element with tapered edges.

FIG. 9 is a longitudinal section of the tubular element with one edge folded inside.

FIG. 10 is a longitudinal section of the conical tubular element with one edge folded inside.

FIG. 11 is a longitudinal section of the conical tubular element with one edge folded outside.

FIG. 12A is a one layer tubular element folded edge.

FIG. 12B is a three layer tubular element folded edge.

FIG. 13 is a cross-section of the tubular element with different shapes.

FIG. 14 is a different pattern of knurls.

FIG. 15 is a cross-section of the different knurls.

FIG. 16 is a longitudinal section of the tubular element with one folded edge and with bottom.

FIG. 17 is a longitudinal section of the tubular element with one folded edge, bottom, and stiffness ribs.

FIG. 18 is a prospective view of the tubular element with stiffness ribs different shape (before knurls and after stiffness ribs).

FIG. 19 is a prospective view of the tubular element with flats.

FIG. 20 is a prospective view of the tubular element with wetting.

FIG. 20-A wetting is fulfilled before paper is conveying to working zone for forming.

FIG. 20-B paper wetting is fulfilled during forming process.

FIG. 20-C paper wetting is fulfilled when all the forming process or one (several) of the forming process stages are finished.

FIG. 20-D wetting process is fulfilled on further (late) stages of paper peanut production or in bunker.

FIG. 21 general design of the machine for tubular element manufacturing. 1-paper; 2-paper source (paper roll holder); 3-paper unroll device; 4-tension device; 5-paper cutter (knife); 6-winding mechanism; 7-wetting device; 8-knurls forming device (instrument); 9-edge(s) folding mechanism; 10-knurls forming device; 11-dryer; 12-feeder; 13-bunker.

FIG. 22 is a paper winding and edge folding general view.

FIG. 23 is a different ways of paper supply into winding mechanism. A-strait; B-not strait (underangle).

FIG. 24 is an example of paper patterns. A-pattern for cylindrical tubular element; B-pattern for tubular element with tapered edges; C-pattern for conical tubular element; D-paper supply with preliminary stamping. 1-paper; 14-special pattern half-finished article; 15-stamping instrument; 5-cutter.

FIG. 25 is a tubular element forming: winding, edge folding, knurls forming. 1-paper; 6-winding mechanism; 8-knurls forming instrument; 9-edge(s) folding mechanism; 16-holder.

FIG. 26 is a cylindrical tubular element winding. 1-paper; 6-winding mechanism; 16-holder.

FIG. 27 is a conical tubular element forming winding, edge(s) folding combined with knurls forming, wetting and drying. 1-paper; 6-winding mechanism which consists of several parts; 8-knurls forming device (knurling instrument); 16-holder; 17-edge(s) folding mechanism with nozzle and drying by hot instrument.

FIG. 28 is a conical tubular element forming mechanism with grip. 9-edge(s) folding mechanism; 18-winding mechanism which consists of grip and split central rod where detachable parts can move in different directions 19-edge(s) folding mechanism with grip holder.

FIG. 29 is a conical tubular element forming mechanism with grip. 9-edge(s) folding mechanism 18-winding mechanism which consists of central rod and grip; 19-edge(s) folding mechanism with grip holder.

FIG. 30 is a tubular element winding mechanism with springs.

FIG. 31 is a tubular element forming mechanism with springs and ribs.

FIG. 32 is a forming mechanism for tubular element with ribs and openings.

FIG. 33 is a forming mechanism for polygon tubular element.

FIG. 34 is a working zone area where edge folding combined with knurls forming in edge(s) area. A-flat folding. B-folding with overhanging.

FIG. 35 is an examples of different distributions of different knurls patterns on the half-finished article. A-D on all surface. E, F on central area. G, H Cross-section of layers joining.

FIG. 36 is a different instruments for knurling rolling. A-conventional knurling instrument. B-knurling instrument for forming knurls with different pattern for each layer. C-knurling instrument for forming knurls with different patter on each layer and areas of each layer.

### DESCRIPTION OF THE PREFERRED EMBODIMENTS

A packaging material in accordance with the present invention includes a plurality of tubular elements hereinafter referred as tubes. The tube is composed of paper or paper products, for instance, any kind of paper, cardboard, etc. When the paper tube is made, the amount of paper layers can be one or more. The amount of the layers can be variable along the lengths of the paper tube. At least one edge of the paper tube is folded, or both edges of the paper tube can be folded as shown in FIG. 1. This imparts to the paper tube proper carrier properties, to improve its lateral stiffness. At least one paper tube edge is folded (beaded, wrapped, is made with beading) as shown in FIG. 3. The folded edge increases rigidity of the paper tube as stiffening rib. The edge(s) folding is performed tightly, preferably with no gap between the turns as shown in FIG. 3, to provide compression stiffness and carrier properties. The amount of edge(s) folding turns can be one or less than one as shown in FIGS. 1, 12A. However, it is preferable to produce the paper tubes in which the number of edge(s) folding turns if more than one as shown in FIGS. 3, 12B.

Taking into consideration the carrier properties at the one hand and the limitations of paper tube weight at the other hand, approximately 2-4 times folding is optimal. The paper tube can be made by winding (bending, coiling) from a preliminarily produced paper tube and/or by any other method. The paper can be preliminarily formed with corrugations, as a multilayer paper where each layer is different, etc. The paper tube can have different shapes as shown for example in FIGS. 1, 2, 4, 5, 6, 7, 8, 9, 10, 13A-13F, 16, 17, 18, 19. Another versions of shapes are also possible.

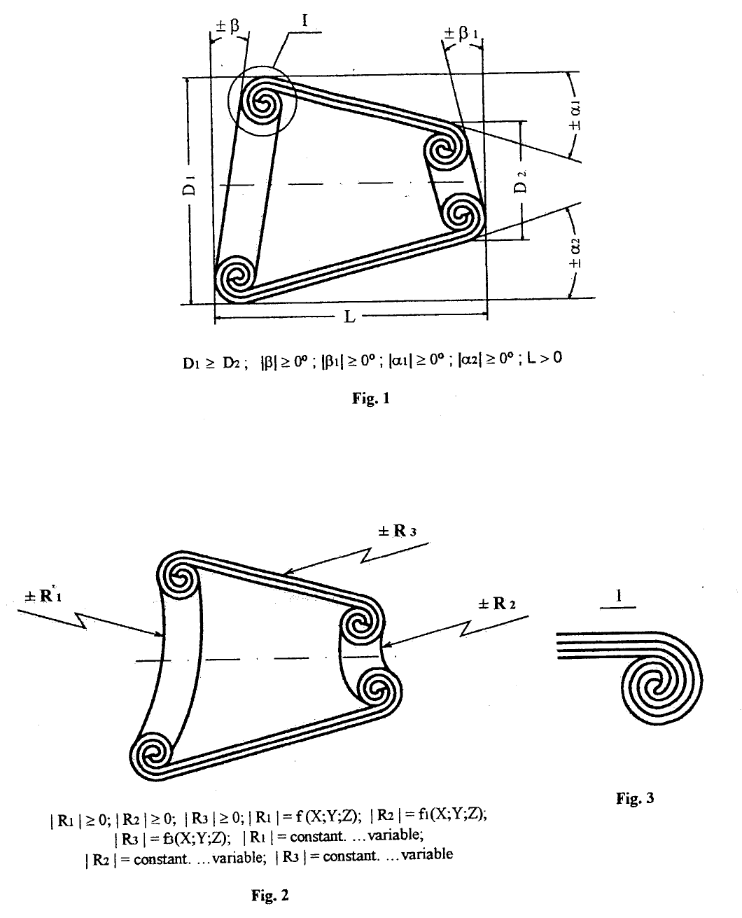

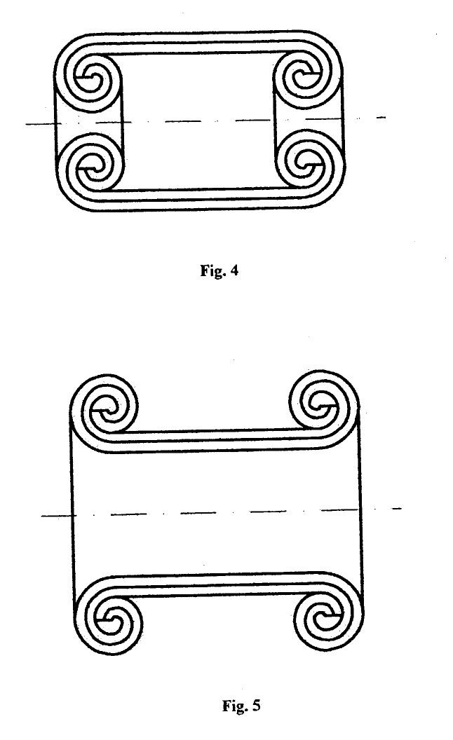

The paper tube can have a cylindrical shape as shown in FIG. 4 (α₁=0°, α₂=0°) or a conical shape as shown in FIG. 1 (|α₁, α₂|>0°). The generating line of the paper tube which is parallel to the paper tube longitudinal axis can be a strait line or can have a regular curvature (R₃-constant) or irregular curvature (R₃-variable) as shown in FIG. 2.

The end in the bracket(s) of the paper tube can be perpendicular to the longitudinal axis (β=0°, β₁=0°) as shown in FIGS. 5-11, or angles |β| and |β₁| can be different from 0° as shown in FIGS. 8-20D. It is also possible that one end is perpendicular to the longitudinal axis (β or β₁=0°) while the other end is not equal to 0° (|β| or |β₁|).

The generating line of the ends of the paper tube can be a strait line or can have a regular curvature (R₁, R₂ are constant) as shown in FIG. 1 or irregular curvature (R₁, R₂ are variable) as shown in FIG. 2.

Different shape, straitens and curvatures of the generating lines of the paper tube influence a relative density of filling by the paper tubes of a unit volume and influence consequently the amount of paper tubes per unit volume (for example, the amount of paper tubes per cubic feet). The style of the paper tube edge(s) folding shown in FIGS. 4, 5, 6, 7, 8, 9, 17, the paper tube design shown in FIGS. 1, 18, 19, the ratio of different types (shapes) and the ratio of different paper tube dimensions in the unit volume, as well as other parameter influence a relative density of filling as well.

The style of the paper tube edge(s) folding (beading, rolling, wrapping) is directly connected with the structural strength and toughness as well as with a bulk density (volume density) of the inventive material. There are two alternative conditions to be considered. First is a maximum toughness and carrier ability, while a second is a minimal weight of packaging. The style of the paper tube edge(s) folding (beading, rolling, wrapping) can be chosen according to these demands.

When the paper tube edge(s) is made with a folding (beading, rolling, wrapping) inside as shown in FIG. 2, the amount of the paper tubes per volume increases, but also a packaging unit weight increases. The filling by the paper tubes if tighter that leads to inclement of packaging carrier ability.

Paper tube edge(s) made with folding (beading, rolling, wrapping) outside as shown in FIG. 5 allows a reduction of packaging unit weight or less amount of paper tubes in volume. It should be mentioned that when the paper tube edge(s) is made with folding (beading, rolling, wrapping) outside, the internal stress increases in folded edge. Enhancement of the internal strengths increases the rigidity of the paper tube and its carrier ability.

Production of paper tubes when both edges or one edge are made with folding (beading, wrapping) outside as shown in FIGS. 1, 2, 4 is not possible in all cases. The type and properties of used paper, the level of wetting, the paper tube dimensions of used paper, the level of wetting, the paper tube dimensions, and other facts considerably affect the conditions when the paper tube was folded (beading, rolling, wrapping) outside edge(s) are produced. In some cases the above mentioned factors eliminates such a possibility.

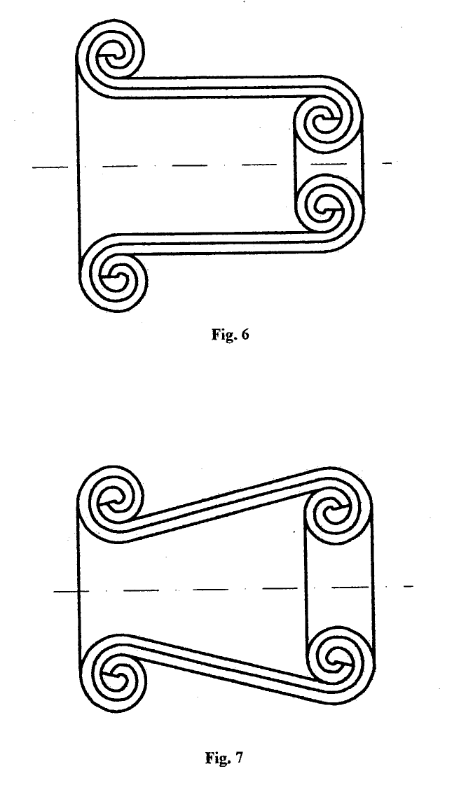

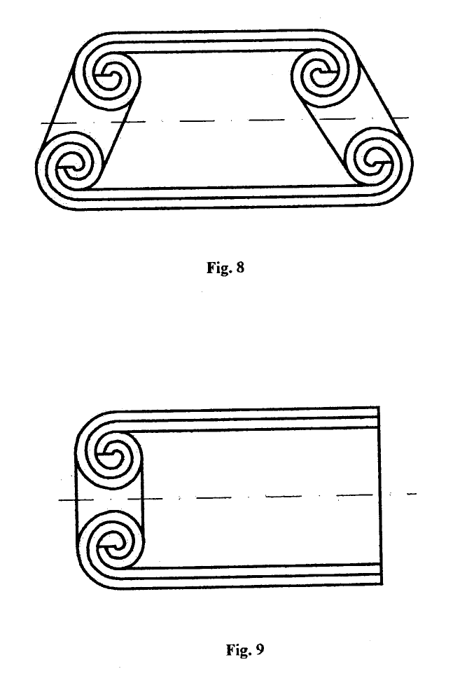

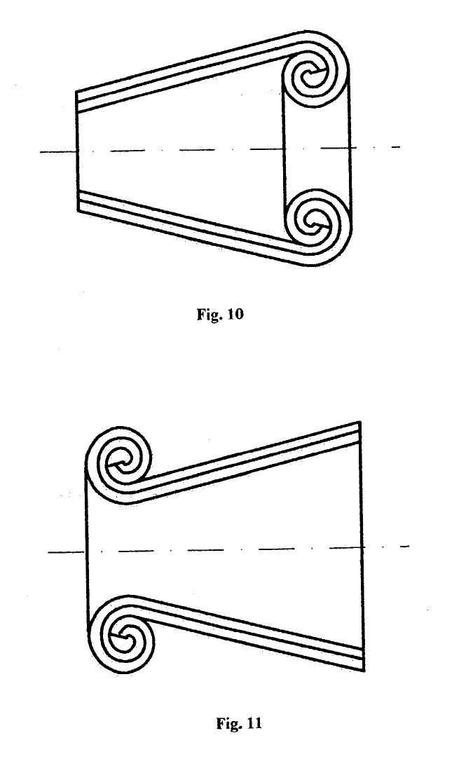

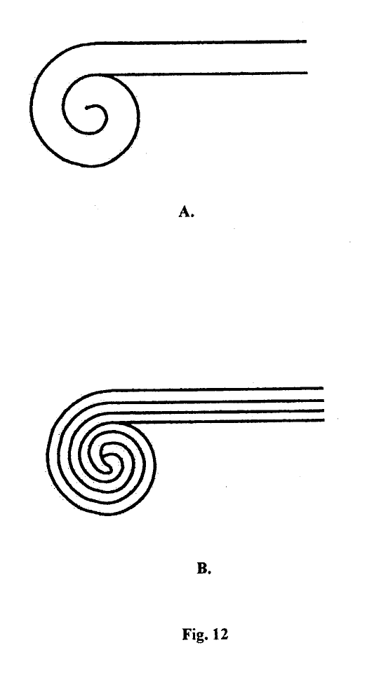

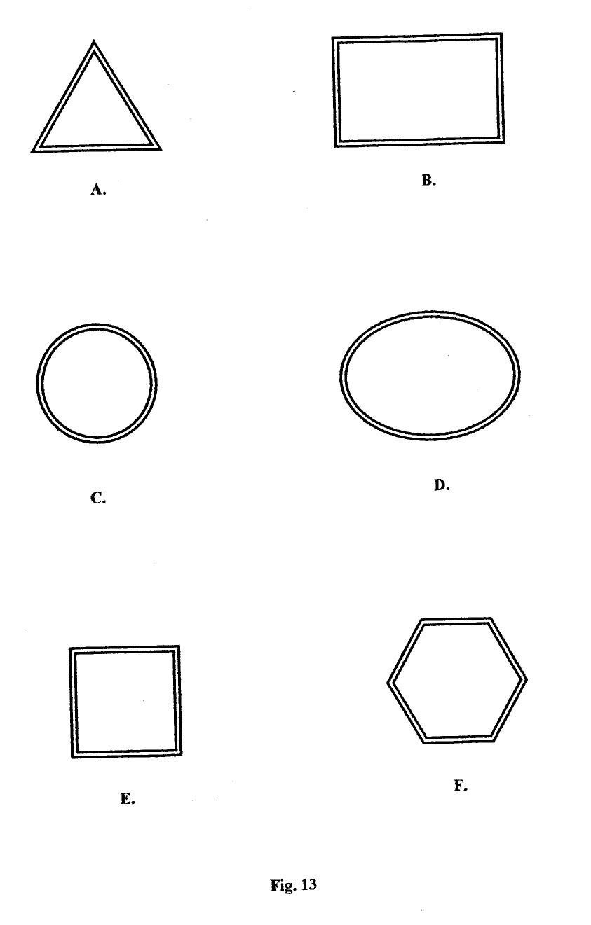

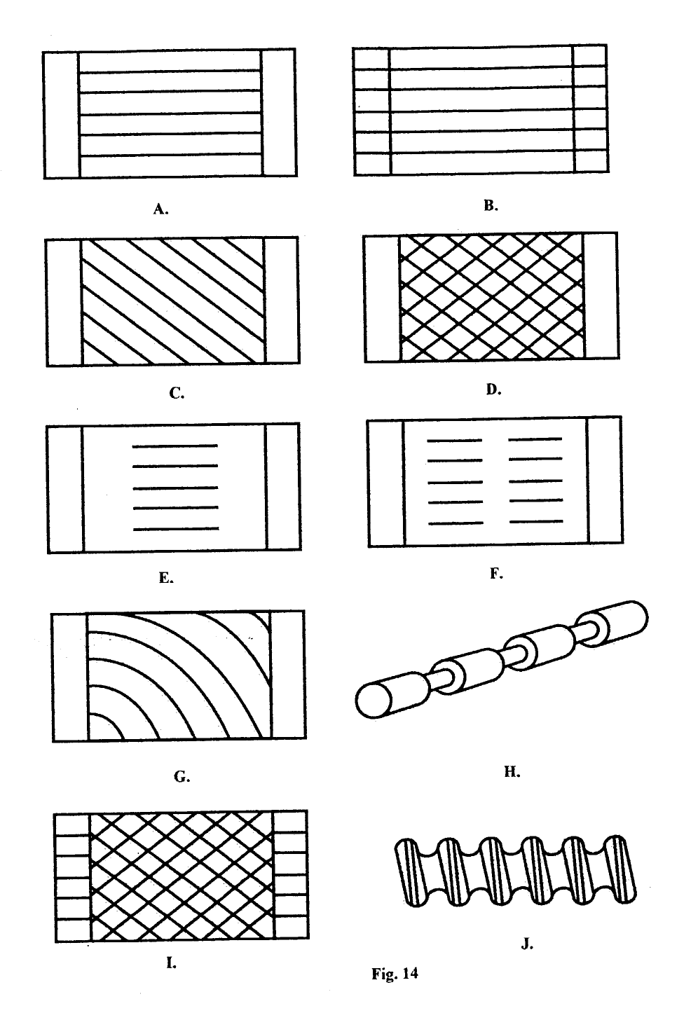

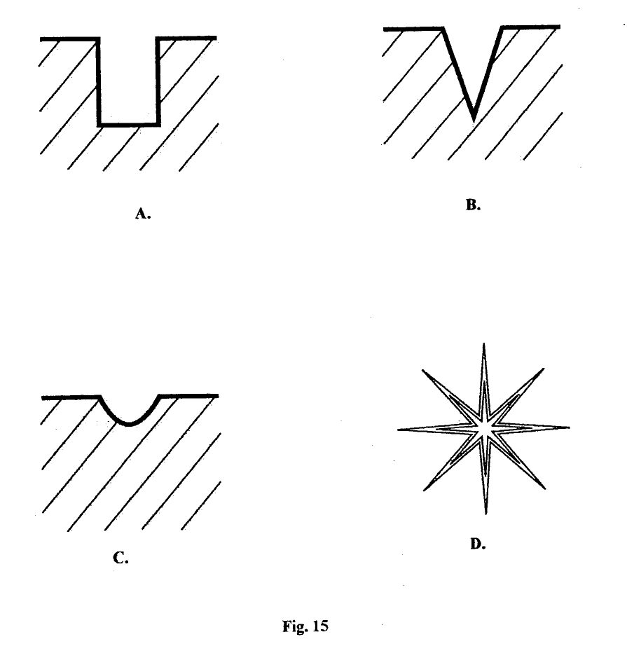

The paper tube can be either cylindrical, or conical, or of another shape. FIG. 4 shows a cylindrical paper tube with two edges folded inside. FIG. 5 shows a cylindrical paper tube with two edges folded outside. FIG. 6 shows a cylindrical paper tube with one edge folded inside, and the other edge folded outside. FIG. 7 shows a conical tube as one edge folded inside and the other edge folded outside. FIG. 8 shows a cylindrical tube with inclined edges folded inside. FIG. 9 shows a cylindrical tube with one edge folded inside. FIG. 10 is a view showing a paper tube with a larger diameter edge folded inside. FIG. 11 shows a conical paper tube with a smaller diameter end folded outside. The combinations of these designs are possible as well. These designs are provided for achieving corresponding rigidity and low packaging unit weight. Whereas precautions are possible to prevent self-uncoiling (self-unwrapping). For example, a special wetting agent can be used, knurls can be formed on the surface of the paper tube as shown in FIG. 14, etc. The paper tubes as shown herein above can have strait or curved generating lines and strait or inclined edges.

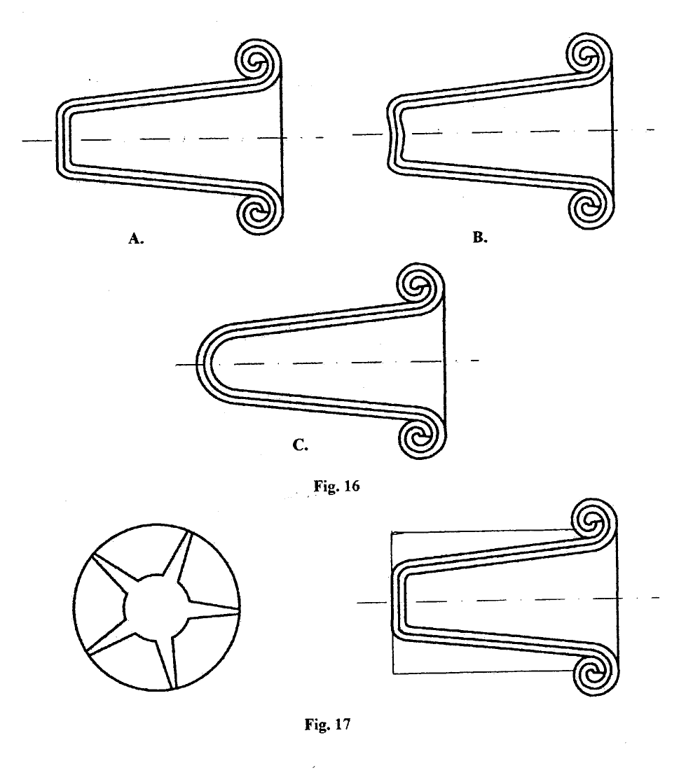

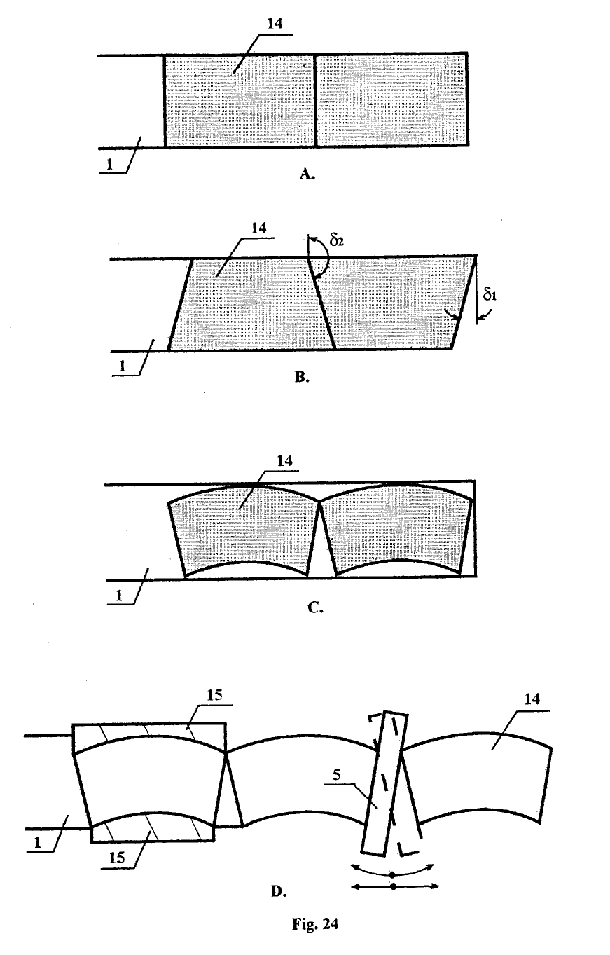

The paper tube can be formed of a paper with a special pattern as shown in FIG. 24. A method of producing can be different, for example a paper tube have semi-finished article forming can be performed by a stamping technique shown in FIG. 24D. These methods allow producing the paper tubes with a bottom as shown in FIG. 16. The shape of the bottom can be flat as shown in FIG. 16A, with a concavity as shown in FIG. 16B, with a convexity or arch as shown in FIG. 16C or a combination thereof. The edges of the tube can be closed or open as shown for example in FIGS. 16 and 17.

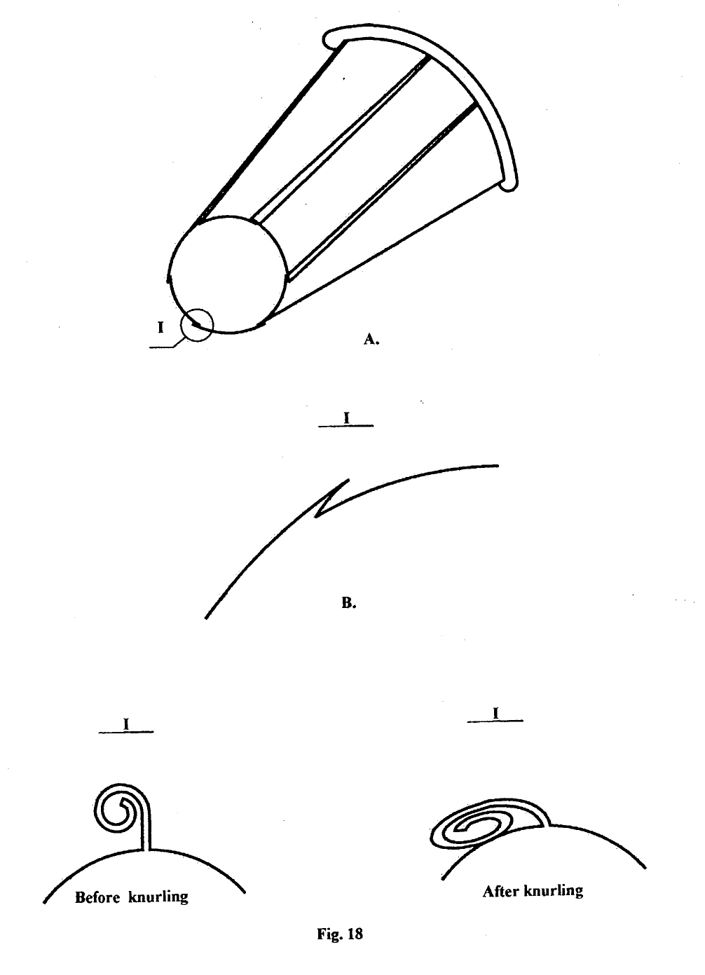

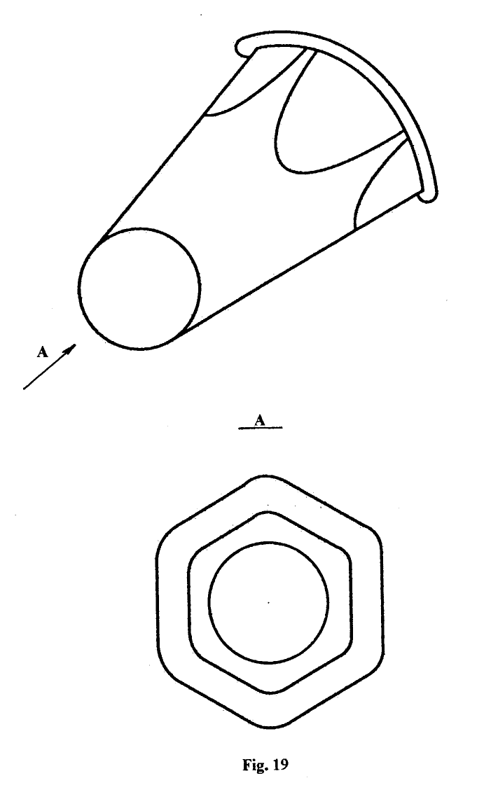

The paper tube can have crimps as shown in FIGS. 18A, 18B. Crimps increase the carrier ability and strengths of the paper tube. The edges of the crimps which are next to an open edge of the paper tube are folded together as shown in FIG. 18A. This provides better rigidity and reduction of filling weight per unit volume. For further increase of the rigidity, each crimp can be made with an additional bending as shown in FIG. 18C. An additional knurling for increasing the paper tube is also possible as shown in FIG. 18D.

FIG. 19 shows that flats can be provided to impart more rigidity and reduce material consumption for simultaneously preserving or decreasing the weight per unit volume. Each flat can extend along the whole length of the paper tube or only over a part of it.

The shapes of the paper tube can be symmetrical or asymmetrical. FIG. 13 shows examples of possible shapes.

Knurls can be provided on the surface of the paper tube to increase this rigidity in carrier ability. The knurls can be various deepness. It can be from hundreds and thousands of inch (knuris on FIGS. 14-A, 14-B, 14-C, 14-D, 14-E, 14-F, 14-G) and up to several inches deep (pit FIG. 14-H, 15-D). Other patterns are also possible, for example in a screw pattern, a spiral line FIG. 14-J, etc. Maximum and minimum deepness depends on many factors, among them paper thickness, paper type and properties, level of paper wetting, technological specifics of manufacturing, knurl shape, etc.

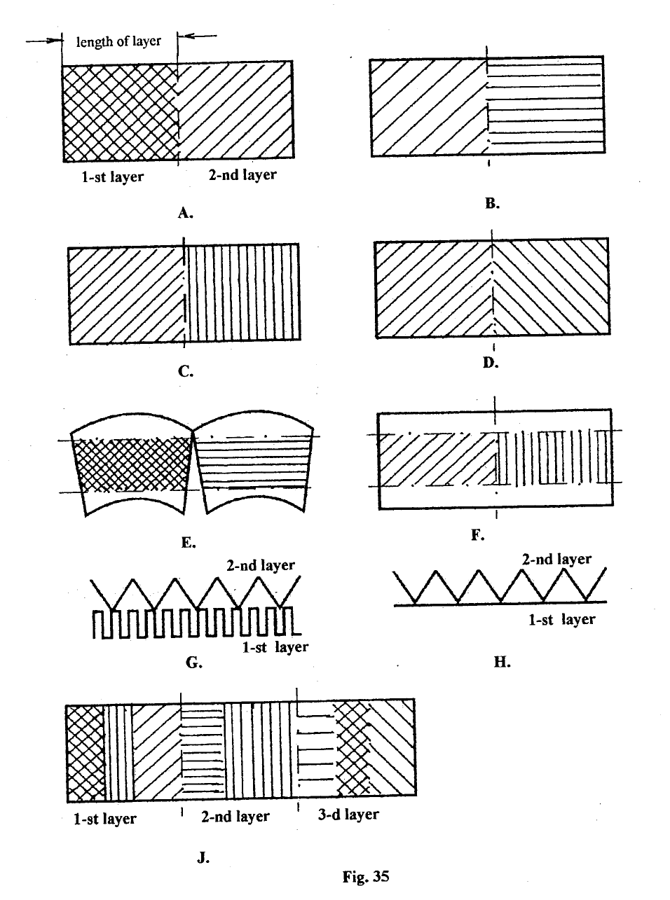

Knurl shapes can be different in each case. FIG. 15 shows some variants of the knurl shapes. A combination of various shapes is also possible. A knurl shape, pattern and deepness can be different on each layer and variable on different areas of each layer. It allows to make the paper tube with a gap between layers, or in other words more puffy. This increases absorption ability as well. Process of knurl forming can be divided in several stages. Each layer can have different patterns of knurls in order to create the paper tube with gaps between layers. FIG. 35 shows some possible knurl pattern combinations. The difference between knurl patterns, can provide incompatibility during superposition of one layer on the other as show in FIG. 35 A, B, C, D, F or areas of layers in FIG. 35G. It is possible that the patterns are the same with different pitch. FIG. 35G shows two different patterns with a different pitch. When each layer has it own knurls pattern, compression strength is equal in all cross sections along the paper tube-regular compression strengths. When each area of each layer is different knurls pattern, compression strengths can be different in each direction and cross section-irregular compression strengths. This can be more even distribution of load inside the container with shipped articles. Morever, the knurls can be made to improve the paper tube look. They can be made as digits, letters, words, and carry out advertising functions as well. In this case it can be also different prints on the paper tubes.

It is possible, than before, after or during of paper tubes production paper or finished product is wetting. Wetting agent can also provide layers agglutination. Agent may include soap, starch, glue, etc. Agent also can provide special properties: antibacterial, non-flammable, etc.

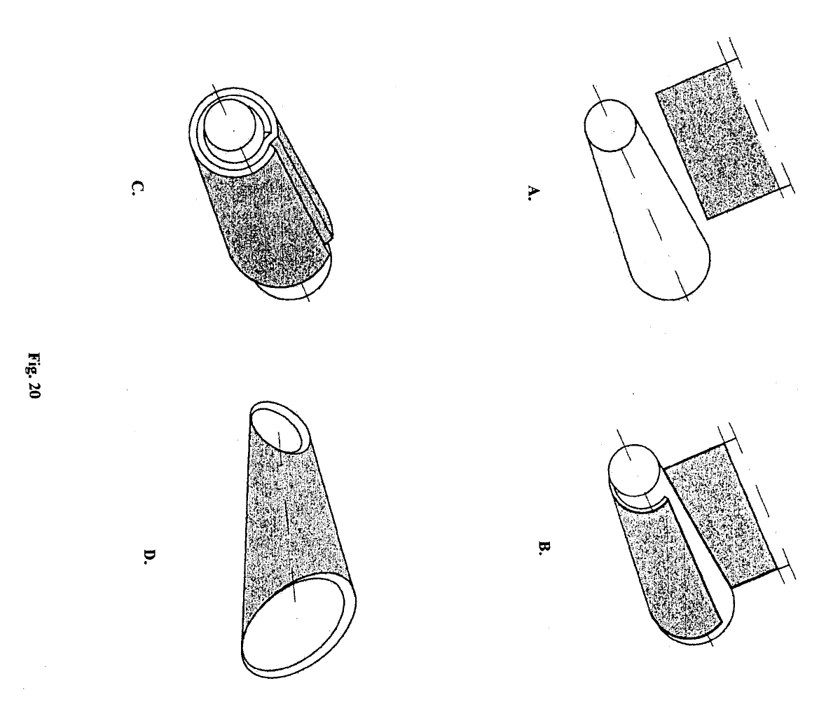

When paper tube or paper for it product is wetting, whole paper tube or some area(s) of paper tubes can be made with wetting and drying FIG. 20. For example, wetting of central area except edges, only edge(s) area, combination of different wetting areas, etc.

Infiltration (impregnation) of paper tube or paper for its manufacturing occurs in order to provide paper tubes with special property. For example, infiltration agent is a solution with non-combustible properties. Wetting, coating, infiltration can be fulfilled by special chemicals. It can be antibacterial, anti-bugs, anti-rodent, or other protective solution. It gives possibilities to protect goods and eliminate risk of cargo poisoning.

Paper has absorption properties. That is very important when liquids are shipped. When the absorption properties should be on a higher level a paper with increased porosity is used for paper tube manufacturing. As it mentioned above, paper tube absorption properties can also be increased by combination of different knurls. Increment of capillary forces in these cases occurs too.

Technological route of paper tube manufacturing will be explained now in detail.

Technological route starts with supplying paper except cases when paper tube are produced from preliminary made tubing or half-finished article with special pattern.

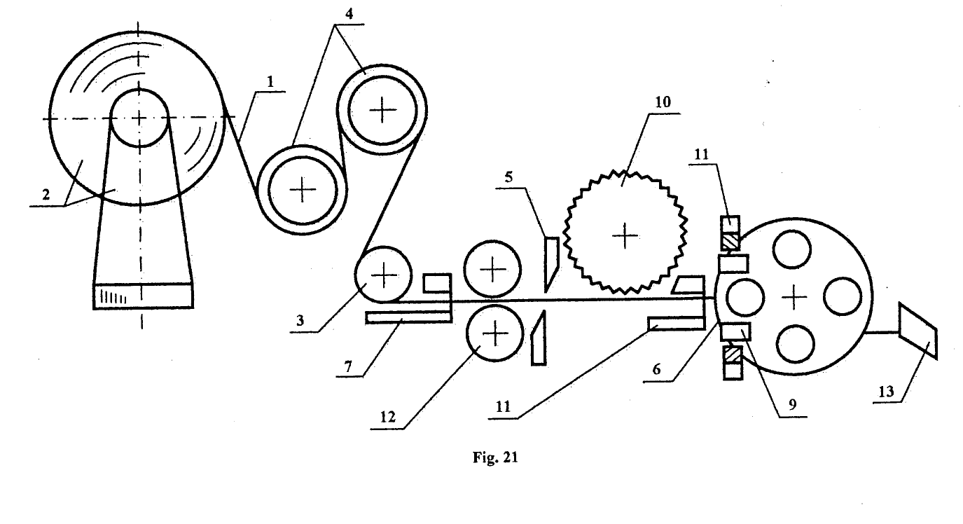

Paper from paper source FIG. 21-2 is supplied into working zone 6 or first position by means of feeder FIG. 21-12. Appropriate pattern and length are provided by cutter(s) 21-5, FIG. 24D-5 and stamping instruments FIG. 24D-15.

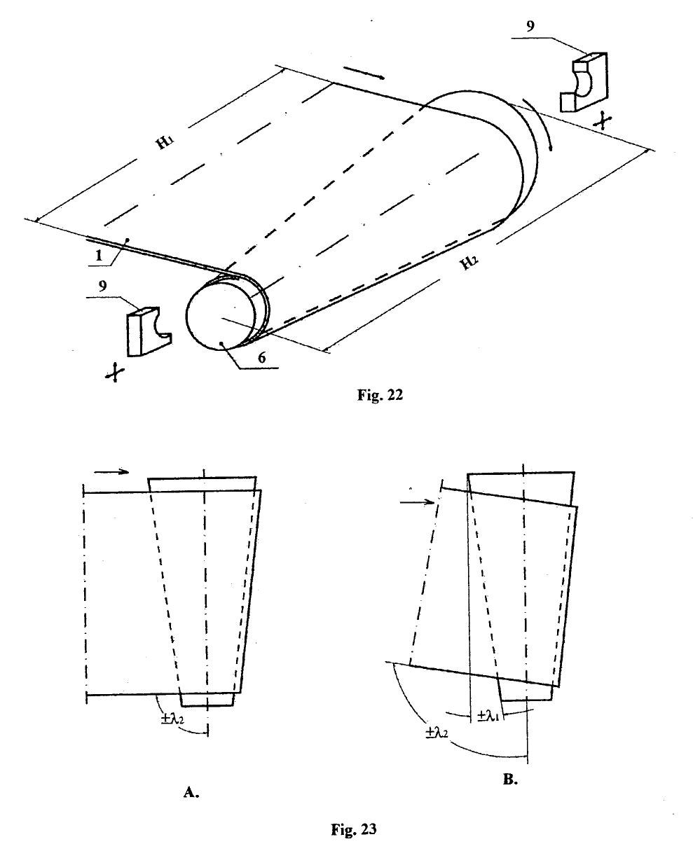

Paper is delivered into working zone 6 (first position) for winding process FIG. 20-A, FIG. 22.

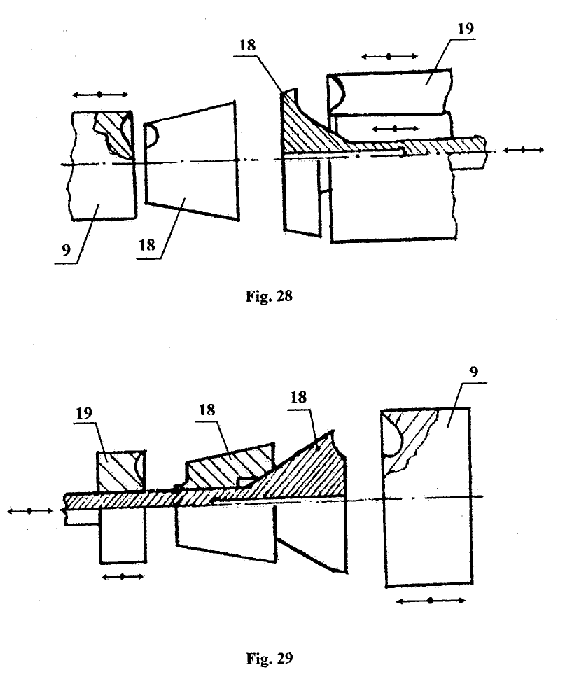

Process of edge(s) folding can be started after winding process is finished. For folding special instruments are used FIG. 21-9, FIG. 25-9, FIG. 27-17, FIGS. 28-9 and 19, FIGS. 29-9 and 19.

On any stage of paper tube production process of knurls forming starts FIGS. 21-8 and 10. That process can be done on any stage of manufacturing. Knurls forming can be even done before winding process. Knurls forming process also can be divided on several stages. For example, first on the central area of paper tube knurls are formed. Than knurls are forming on the edges area of paper tubes. Knurls forming can be combined with another paper tube production operation. For example, knurling and folding (beading), knurling and wetting, or all simultaneously, etc. On FIG. 34 is shown process where folding (beading) is combined with knurling. It is possible when process of knurls forming is divided—first knurls are formed on one part of paper tube and then on other part(s). Process of knurling forming can be divided and made separately as an independent operations.

Applying wetting agent on the paper surface(s) can provide paper wetting FIG. 21-7. In this case wetting agent can have temperature which differs from room temperature. Paper wetting can be provided by means of dipping, moisten, dampen, wet, spraying, vapor, etc. For this goal damper, sprayer (injector, nozzle) and/or other devices should be used.

The wetting agent can be in any state—liquid, vapor and ice. Subsequent paper tube drying takes place.

It is possible that paper wetting takes place before forming processes FIG. 21-7 or during forming stages. For example, nozzle(s) for spraying or vapor is located in working zone of machine for paper tube manufacturing FIG. 27-17.

After wetting process is finished process of drying occurs. Drying process can be done on any stage of paper tube manufacturing and can be combined with any operation.

Drying of paper tube or paper for its production can be realized by special atmosphere (for instance hot air) and/or increased temperature in the working zone and/or in the bunker (hopper) with already produced paper tubes.

When paper tubes forming process is finished the tubes are removed from working zone FIG. 21-9.

Machine for paper tube manufacturing is described herein below.

Machine for paper tube manufacturing has to provide appropriate productivity, should be flexible when paper tube design and dimensions need to be changed. Maintenance and start up should be easy.

General design of the machine for paper tube manufacturing FIG. 21 includes the following main mechanisms or some of these mechanisms.

Mechanism of paper supplies FIG. 21-12 into working zone(s). Usually this mechanism includes paper roll holder FIG. 21-2; device for paper unrolls FIG. 21-3 with tensioning device FIG. 21-4, and paper cutter FIG. 21-5. Mechanism of paper supply into working zone can work discretely in order to supply paper into working zone when forming process of previous paper tube is finished or previous paper tube is removed from working zone or part of working zone in which paper is supplied is empty.

Mechanism of paper winding FIG. 21-6. This mechanism can be duplicated in one machine (as many as is necessary to reach productivity).

Mechanism of paper tube edge(s) folding (beading, wrapping) FIG. 21-9; FIG. 25-9; FIG. 27-17 is located in working zone. Amount of this mechanisms in one machine can be multiplied according to productivity.

Mechanism of wetting by liquid or vapor or ice FIG. 21-7.

Dryer(s). Dryer can be made as independent device or combined (built in) with other components of machine for paper tube manufacturing and located in working zone FIG. 21-=11.

Mechanism(s) of knurls forming FIG. 21-8; 10; FIG. 25-8; FIG. 27-8.

Paper can be supplied into working zone(s) from the top FIG. 22 or from the bottom FIG. 20-B.

The paper edge which is parallel to vector of paper feeding movement can be perpendicular to mechanism of winding (bending) FIG. 23-A (λ₂=90°). Also paper can be feeded to winding mechanism not strait (underangle) FIG. 23-B (λ₂≠90°). Especially when paper tubes with edges which are not perpendicular to long axle are produced FIG. 8. Mentioned above variants are good for cylindrical paper tubes (FIG. 23-A λ₁=0°) and for paper tubes with any shape (FIG. 23-B λ₁≠0°).

Paper tubes are produced from paper that is supplied from roll FIG. 21-2 or special pattern half-finished article FIG. 24 is feeded to working zone. Half-finished article need to have certain pattern to produce paper tubes with special geometry. On FIG. 24-A, 24-B, 24-C, 24-D examples of different half-finished articles patterns are shown. It is possible to feed in working zone single half-finished articles as well as paper from roll. Supplying paper from roll with coincidence stamping FIG. 24-D to obtain certain pattern provide possibilities for productivity increment and simplifies design of machine for paper tube manufacturing.

On FIG. 24-D: 1-paper; 15-stamping instruments; 5-cutter (knife); 14-special shape half-finished article. Knife (cutter) for paper cutting has several degrees of freedom—in place X-Y and rotational degree of freedom FIG. 24-D. During one cycle (supplying one piece of paper for one paper tube manufacturing) cutter 5 can change it location and/or orientation. That provides different geometry (shape) of half-finished article FIG. 24. For example, on FIG. 24-B one end of the half-finished article is cutted with sharp angle (δ₁<90°) and another with obtuse angle (δ₂<90°).

There are several possibilities of conceptual design of machine for paper tube manufacturing.

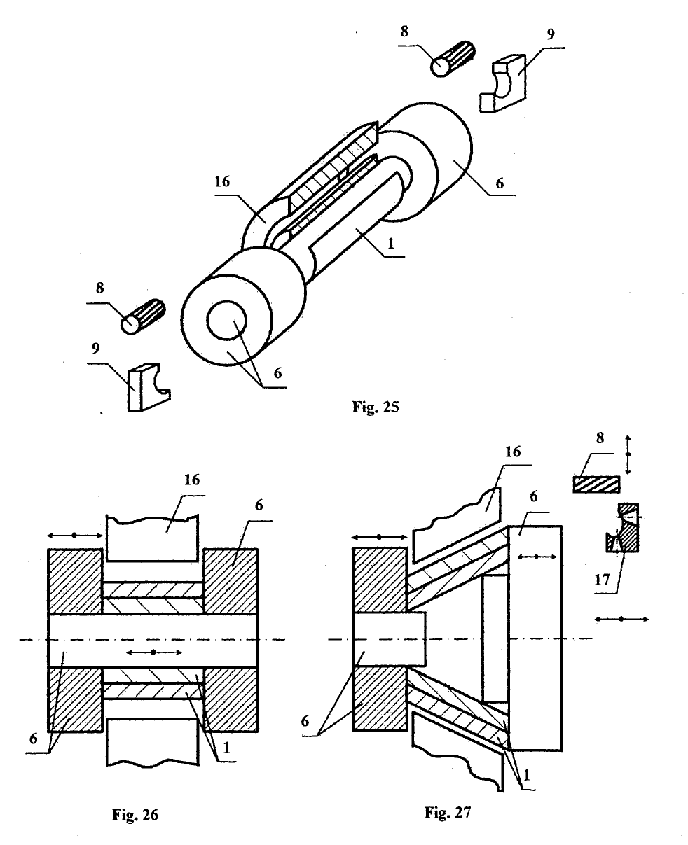

First, when process of winding is finished FIG. 25, instrument(s) for folding FIG. 25-9 is delivered into working zone on initial position. Folding process occur. During that winding instrument can remain in working zone or can be removed or part of winding instrument can be removed. It depends on specific design of winding instrument and instrument(s) for folding FIG. 26, 27, 28, 29, 30. As it mentioned, any stages of paper tube production can be combined FIG. 25, 27, 28, 29. For example, knurls forming instrument delivered in working zone together with folding instrument. Process of knurls forming can be started before folding, simultaneously with folding, with some advance/delay, or combination of these. The same conception of different operation combining is actual for wetting, infiltration, drying, etc.

Second, when working zone consists of several zones and different stages of production are fulfilled with transferring of paper tube semi-product into different zones. Combining of operation is possible as well. Such type of design mostly suitable for rotary machine for paper tube manufacturing.

When processes of edge(s) folding and knurls making are combined (working zone of machine in FIG. 27-17 and 8; FIG. 34A; FIG. 34B) it allow to increase folding tightness and stiffness in edge area. That led to increment of paper tube compression stiffness. Those improve paper tubes rigidity and carrier ability. Better improvement of folding tightness if reached when knurling is made with delay relatively to beginning of edge(s) folding process. Further improvement of mentioned properties can be reached when folding and knurling processes are fulfilled with preliminary wetting FIG. 20; 27 and further drying. When drying speed is higher than drying on air, additional increment of rigidity is reached. In this case hot forming of paper tubes take place. For instance, drying by means of hot instrument.

Edge folding combined with knurls forming in edge(s) area. Flat edge FIG. 34A or edge with overhanging FIG. 34B.

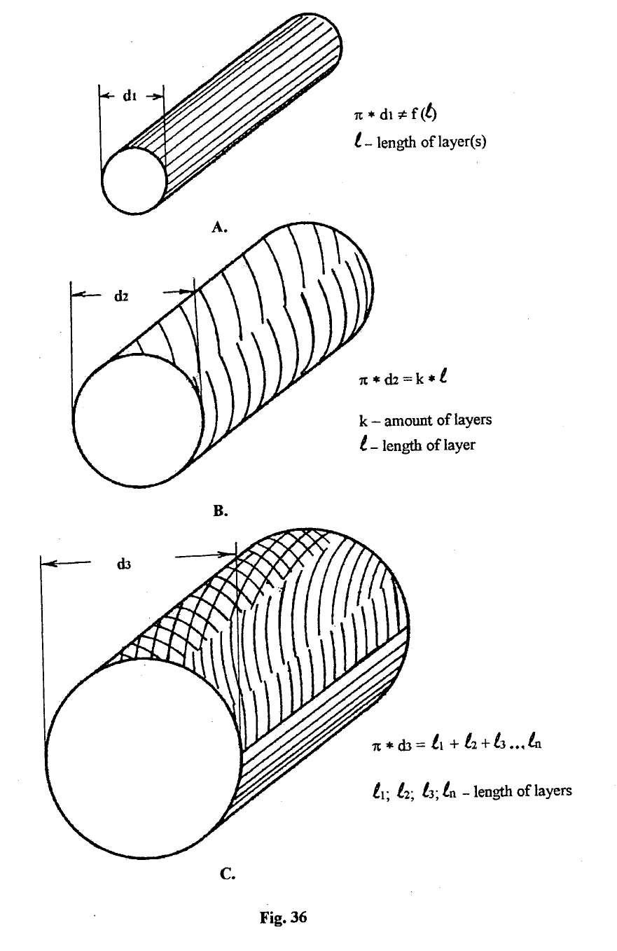

As it mentioned above process of knurls forming can be divided on several different operations FIG. 21: knurls forming in central area FIG. 21-10 and on later stage knurls forming on edge(s) area FIG. 21-8. When paper tubes with different knurls pattern on layers or areas of layers are produced special instrument or combination of instruments should be used. On FIG. 36 different instruments for knurling are shown. FIG. 36A—conventional knurling instrument. FIG. 36B—knurling instrument for forming knurls with different pattern for each layer. FIG. 36C—knurling instrument for forming knurls with different pattern on each layer and area of each layer.

Example of the design of machine for paper tube manufacturing is shown on FIG. 25. Paper 1 (or special pattern half-finished article) is winded by means of winding forming instrument 6 and holded by holder 16. When winding process is fulfilled paper tube edge(s) is folded by edge(s) forming instrument 9. Knurling instrument FIG. 25-8 is located in working zone or one of the working zones. As it mentioned above processes of wetting, drying, knurls making can be combined with paper tube forming process.

On FIG. 26 is shown winding forming instrument 2 made from several parts. After winding the winding forming instrument 6 (or some it components) is (are) removing from certain working zone. Also winded half-finished article (FIG. 26-1; FIG. 27-1) can be transferring to another position. Than edge(s) is folded by edge(s) forming instrument FIG. 25-9; FIG. 27-17.

Holder FIG. 25-16; FIG. 26-16; FIG. 27-16 can remain, be removed, or transferred together when winded half-finished article FIG. 26-1 is transferred to another position.

For production of paper tubes with complex geometry different design of forming instruments and forming mechanism can be used FIG. 21, 26, 27, 28, 29. On FIG. 29 is shown design with grip mechanism analogous to design on FIG. 26—winding rod consists of one component (but can be several parts FIG. 29). On FIG. 27 shown one of the variants where central component of winding mechanism consists of several parts that are made as grip mechanism and can be removed in different directions—analogous to design on FIG. 27.

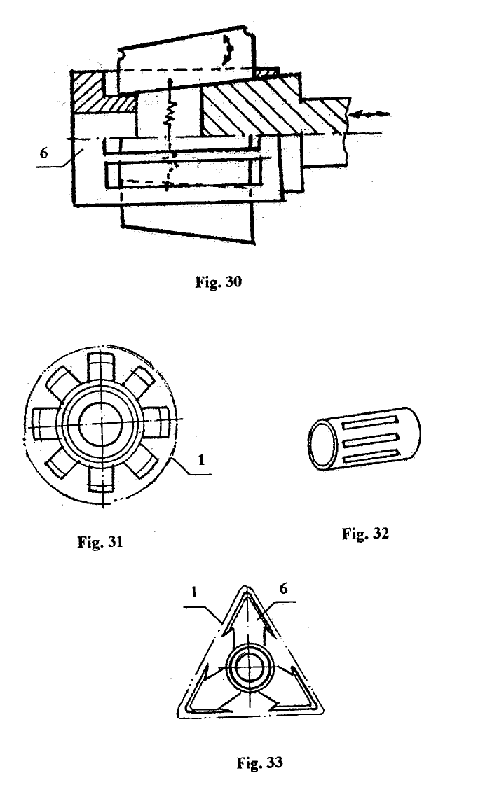

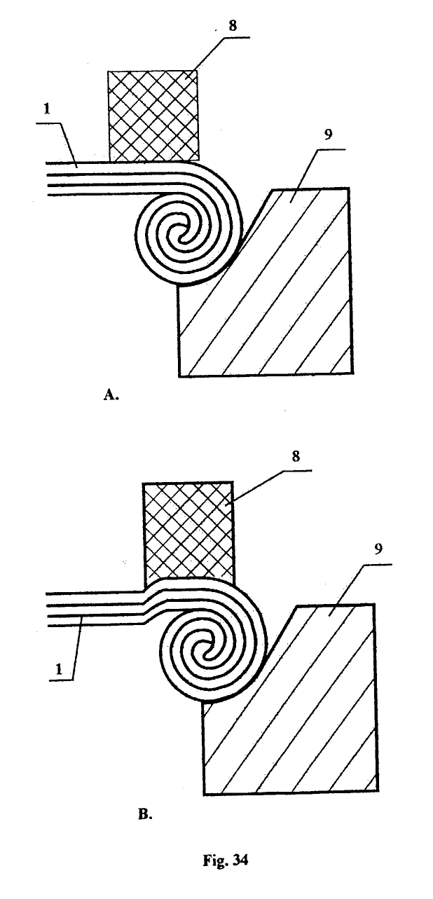

Production of complex shape paper tubes can be solved by wide variety of designs. On FIG. 30 shown mechanism with spring-actuated parts. That allows producing paper tubes with openings, stiffening ribs, polygon shape, etc.

Working zone can consist of several zones. Half-finished article can be transferred from one zone to another. Also is possible when into the same working zone (position) different instruments (included forming instrument) can be delivered in certain sequence. For instance, in the first zone winding and knurling occur. Knurling is made on one part of paper tube surface—only on central part, or on edges area, etc. Then half-finished article is transferred to another working zone where edge(s) is folded. That can be combined with simultaneously next area knurling or further knurling is made in further working zone (position).

It is possible that forming instrument(s) FIG. 27-17 can be made with nozzle(s) or other device(s) mounted inside. Wetting agent is supplied throw these nozzle(s) or other device(s). In addition forming instrument(s) is heated to provide paper tubes drying while producing.

Wetting can be done on any stage of paper tube production FIG. 20. Paper wetting can be done before paper is conveying to working zone for forming. FIG. 20-A. Paper wetting can be done during forming process FIG. 20-B. Paper wetting can be done when all the forming process or one (several) of the forming process stages are finished FIG. 20-C. It is possible to fulfill the wetting process on further (late) stages of paper tube production or in bunker FIG. 20-D. Function of wetting can be fulfilled by special wetting device or forming instrument or other machine components can combine that function. For example, folding instrument made with nozzles FIG. 27-17.

Accordingly the drying process occurs after wetting and also can be done on any stage(s).

Machine for paper tube manufacturing can include special Dryer. Function of Dryer can be realized by special design of forming instrument(s) or another components of machine for paper tubes manufacturing. In this case forming instrument(s), or another machine components, is heated (hot instrument and/or machine components) to provide paper tubes drying while producing.

It will be understood that each of the elements described above, or two or more together, may also find a useful application in other types of constructions and methods differing from the types described above.

While the invention has been illustrated and described as embodied in a packaging material, and method of and machine for producing the same, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A packaging material, comprising a tubular element composed of a material selected from the group consisting of paper and a paper product, said tubular element having an axis and two axial edges spaced for one another, at least one of said edges being folded in a direction selected from the group consisting of inwardly, outwardly and both.

2. A packaging material as defined in claim 1, when said tubular element has a shape selected from the group consisting of a conical shape and a cylindrical shape.

3. A packaging material as defined in claim 1, when at least one of said edges is formed as an edge selected from the group consisting of straight edge, an inclined edge and a curved edge.

4. A packaging material as defined in claim 1, wherein said tubular element has a generatrix with a shape selected from the group consisting of a line, an inclined line and a curved line.

5. A packaging material as defined in claim 1, wherein said tubular element is composed of several layers.

6. A packaging material as defined in claim 1, when said tubular element is provided with a plurality of knurls.

7. A packaging material as defined in claim 5, wherein said layers are provided with knurls such that the knurls of different layers are different.

8. A packaging material as defined in claim 1, wherein said material of said tubular element is a material which is initially wetted and subsequently dried.

9. A packaging material as defined in claim 1, when said material is provided with a coating.

10. A packaging material as defined in claim 1, wherein said material is impregnated with a substance.

11. A method of producing a packaging element, comprising the steps of forming a tubular element of a material selected from a group consisting of paper and a paper product and having an axis and two axial edges spaced from one another in an axial direction; and folding at least one of said edges in a direction selected from the group consisting of inwardly, outwardly and both.

12. A machine for producing a packaging element, comprising means for forming a tubular element composed of a material selected from the group consisting of paper and a paper product and having an axis and two axial edges spaced from one another in an axial direction; and means for folding at least one of the edges of the tubular element in a direction selected from the group consisting of inwardly, outwardly and both.

13. A machine as defined in claim 12; further comprising means for preliminarily wetting the material; and means for subsequently drying the wetting material of the tubular element.

14. A machine as defined in claim 12; further comprising several instruments arranged in several zones so that semi-finished article for producing the tubular element is transferable from one zone to another where it remains in one working zone.

15. A machine as defined in claim 13, wherein said wetting means include a plurality of nozzles for supplying a wetting agent.

16. A machine as defined in claim 13, when said drying means include a dryer for drying the tubular element.
